(19) United States
(12) Patent Application Publication
(10) Pub. No.: US 2017/0326023 A1
(43) Pub. Date: Nov. 16, 2017

(54) ARM VIBRATION DAMPING DEVICE

(71) Applicant: GYENNO TECHNOLOGIES CO., LTD., Nanshan District, ShenZhen (CN)

(72) Inventors: Yaping ZHU, ShenZhen (CN); Kang REN, ShenZhen (CN)

(73) Assignee: GYENNO TECHNOLOGIES CO., LTD., Nanshan District, ShenZhen (CN)

(21) Appl. No.: 15/532,312

(22) PCT Filed: Sep. 16, 2015
(86) PCT No.: PCT/CN2015/089793

§ 371 Date: Jun. 1, 2017

(30) Foreign Application Priority Data
Dec. 5, 2014 (CN) 201420760168.8

(51) Int. Cl. A61H 23/00; A47C 16/00

(52) U.S. Cl. CPC A61H 23/00; A47C 16/00; A61H 2205/06; A61H 2201/5058

(57) ABSTRACT

An arm vibration damping device, comprising a housing (9), a longitudinal vibration damping module (1) and a transverse vibration damping module (2), the longitudinal vibration damping module (1) comprising a longitudinal motor (11), a support frame (12) and a mounting frame (13), the mounting frame (13) comprising a U-shape element (131) and a mounting element (132); the support frame (12) being located between the U-shape element (131) and two arms, the longitudinal motor (11) being in a transmission connection with the U-shape element (131); a transverse motor (21) of the transverse vibration damping module (2) being in a transmission connection with the support frame (12) via a reverse mechanism (22); the transverse motor (21), the support frame (12), the U-shape element (131) and the mounting element (132) being arranged along an axial direction of the transverse motor (21). Vibration can be cancelled through movements in a longitudinal direction and in a direction of the longitudinal vibration damping module, and the use of two arms of the U-shape element ensures the stability of the whole mounting frame and a components fitted thereon in a longitudinal movement.

### TECHNICAL FIELD

The present invention relates to a human body movement assisting device, and more particularly to an arm vibration damping device.

### BACKGROUND OF ART

The industrialization and urbanization the Chinese society in rapid transformation is experiencing are rarely seen in the world in both speed and scale. However, rapid socioeconomic development has also increased the risk of chronic disease. At present, there are about 260 million people with confirmed chronic diseases in China, accounting for about 19% of the total population. The treatment of chronic diseases is divided into drug treatment and physical therapy. Although drug treatment is dominant at present, there are also the risks of misdiagnosis and side effects of drugs. Although it seems that physical therapy is a better way, appropriate auxiliary tools are not available to help patients to accept better treatment and persist for a long time.

Tremor is the most common clinical symptoms of many chronic diseases, such as, Parkinson's disease and idiopathic tremor. The use of physical tools to help patients with tremor to overcome and reduce the discomfort caused by tremor, on the one hand, can achieve the effect of physical therapy, on the other hand, can also increase the patient's treatment confidence. In the prior art, devices for reducing arm vibration are complicated in vibration-damping structure and have poor vibration-damping performance, thus limiting the use of them.

### SUMMARY OF THE PRESENT INVENTION

The present invention is intended to provide an arm vibration damping device, which is simple in vibration-damping structure, good in vibration-damping performance and simple to use.

In order to solve the above-mentioned problem, the present invention provides an arm vibration damping device, comprising a housing, a longitudinal vibration damping module and a transverse vibration damping module, wherein the longitudinal vibration damping module and the transverse vibration damping module are both arranged in the housing, the longitudinal vibration damping module is used for driving fittings to carry out longitudinal vibration damping, and the transverse vibration damping module is used for driving the longitudinal vibration damping module and fittings to carry out longitudinal vibration damping;

the longitudinal vibration damping module comprises a longitudinal motor, a support frame and a mounting frame; the longitudinal motor is mounted on the support frame; the mounting frame comprises a U-shaped member and a mounting member used for mounting fittings; the joint of the two branch arms of the U-shaped member is fixedly connected with the mounting member; the U-shaped member is rotatably connected to the support frame and a rotating shaft of the U-shaped member is parallel with the arrangement direction of the two branch arms; the support frame is located between the two branch arms of the U-shaped member; the longitudinal motor is in transmission connection with the U-shaped member to drive the mounting frame to rotate relative to the support frame; the support frame is rotatably connected to the housing and a rotating shaft of the support frame is vertical to a rotating shaft of the mounting frame;

the transverse vibration damping module comprises a transverse motor and a reverse mechanism used for transmission between two intersecting shafts; the transverse motor is fixed on the housing; the axial direction of the transverse motor is vertical to the rotating shaft of the support frame; the transverse motor is in transmission connection with the support frame via the reverse mechanism to drive the support frame to rotate; the transverse motor, the support frame, the U-shaped member and the mounting member are arranged along the axial direction of the transverse motor.

Wherein the mounting member is of a bar shape, arranged along the axial direction of the transverse motor, one end of the mounting member is fixedly connected with the U-shaped member and the other end extends out of the housing to connect with fittings.

Wherein one branch arm of the U-shaped member is rotatably connected to the support frame while the other branch arm is in transmission connection with the longitudinal motor.

Wherein the rotating shaft of the U-shaped member is parallel with the axial direction of the longitudinal motor.

Wherein the support frame comprises a base and a transmission bar; the base is connected with the U-shaped member and the longitudinal motor is fixed on the base; the transmission bar is arranged along the axial direction of the transverse motor, one end of the transmission bar is fixedly connected with the support frame and the other end is rotatably connected to the housing.

Wherein a roller mechanism is arranged between the base and the inner wall of the housing.

Wherein the reverse mechanism comprises a drive bevel gear and a driven bevel gear which are engaged with each other; the drive bevel gear is in transmission connection with the transverse motor and is driven by the transverse motor to rotate; the driven bevel gear is fixedly connected with the support frame and is rotatably connected with the housing.

Wherein a fixed post is arranged on the inner wall of the housing, and the driven bevel gear is rotatably connected to the fixed post.

Wherein a longitudinal gearbox for reducing speed is arranged between the longitudinal motor and the U-shaped member;

a transverse gearbox for reducing speed is arranged between the reverse mechanism and the transverse motor.

Wherein the arm vibration damping device further comprises a control module; the control module comprises a movement sensor and a control chip; the movement sensor is mounted on the housing and used for collecting the vibration data of the housing; the movement sensor is coupled to the control module to transmit the collected vibration data to the control module; the control module is coupled to the transverse motor and the longitudinal motor, and the control module can control the actions of operation of the transverse motor and the longitudinal motor.

The arm vibration damping device, provided by the present invention, can reduce the influence of arm tremor by virtue of the longitudinal vibration damping module and the transverse vibration damping module which generate movements in two directions to move fittings in a direction opposite to the tremor direction to counteract tremor; in addition, the use of two branch arms of the U-shaped member ensures the stability of the whole mounting frame and fittings during longitudinal movement. The transverse motor, the support frame, the U-shaped member and the mounting member are arranged in the axial direction of the transverse motor so that the axial direction of the transverse motor is located on the central axis of the entire device, and the arrangement of the main components in the direction of the central axis of the device facilitates the structure arrangement of the device on the central axis, so that other electronic elements can be arranged within the housing conveniently. The structure layout of the entire device is reasonable, which will help reduce the size of the entire device, facilitates the hand-held use by users and improves use comfort.

### Brief Description of the Drawings

In order to make the technical solution of the present invention more clear, drawings to be used in embodiments will be introduced briefly hereinafter. Obviously, drawings used in the following description are merely some embodiments of the present invention, and those skilled in the art also can conclude other drawings based on these drawings without paying creative labor.

FIG. 1 is a schematic diagram of an arm vibration damping device provided by an embodiment of the present invention;

FIG. 2 is a schematic diagram of an arm vibration damping device in FIG. 1 from another point of view; and

FIG. 3 is a A-A section view in FIG. 2.

### DETAILED DESCRIPTION OF THE PREFERRED EMBODIMENTS

The technical solutions in embodiments of the present invention will be described clearly and completely hereinafter with reference to the accompanying drawings in the embodiments of the present invention Terms “longitudinal” and “transverse” in the embodiments are, relatively speaking, two directions. It may be understood that “longitudinal” may become “transverse” and correspondingly “transverse” may become “longitudinal” when a user changes the hand-held manner of the arm vibration damping device.

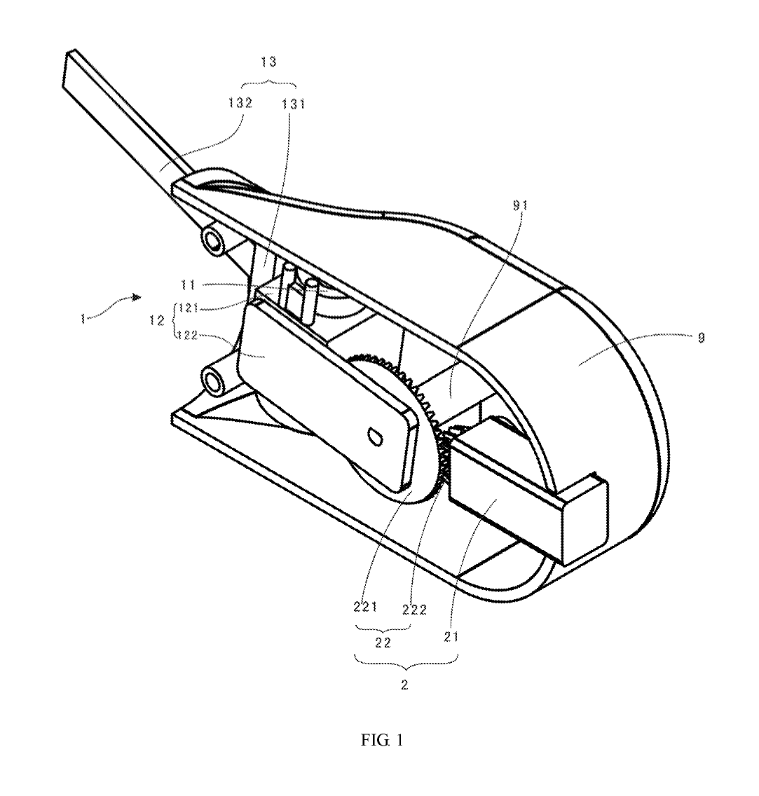

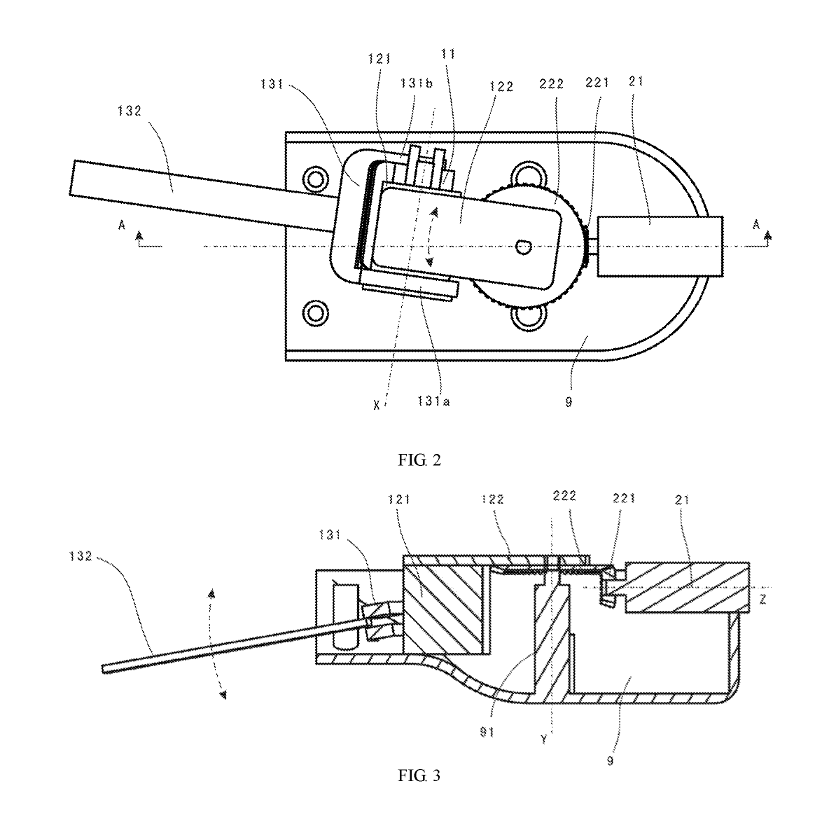

Referring to FIG. 1 to FIG. 3, the arm vibration damping device, provided by the embodiments of the present invention, comprises a housing 9, a longitudinal vibration damping module 1, and a transverse vibration damping module 2, wherein the longitudinal vibration damping module 1 and the transverse vibration damping module 2 are both arranged in the housing 9, the longitudinal vibration damping module 1 is used for drive the fittings to carry out transverse vibration damping, and the transverse vibration damping module 2 is used for driving the longitudinal damping module 1 and the fittings to move laterally. The influence of arm tremor can be reduced by virtue of the longitudinal vibration damping module and the transverse vibration damping module which generate movements in two directions to move fittings in a direction opposite to the tremor direction to counteract tremor. The fittings may be, but are not limited to, customized spoons, chopsticks, key holders, makeup tools, etc.; the fitting may be provided with a connecting base by which the fitting is connected with the longitudinal vibration damping modulel.

The longitudinal vibration damping modulel comprises a longitudinal motor 11, a support frame 12 and a mounting frame 13. The longitudinal motor 11 is mounted on the support frame 12 and is used for driving the mounting frame 13 to rotate relative to the support frame 12.

The mounting frame 13 comprises a U-shaped member 131 and a mounting member 132 used for mounting the fittings. The joint of two branch arms of the U-shaped member 131 is fixedly connected with the mounting member 132. In this embodiment, the mounting member 132 is of a bar shape, arranged along the axial direction of the transverse motor 21, one end of the mounting member 132 is fixedly connected with the U-shaped member 131 and the other end extends out of the housing 9 to connect with fittings. The mounting member 132 may be matched and connected with a connecting structure on a fitting, and a connecting structure also may be arranged on the mounting member 132 to connect with the fittings; the connecting structure on the mounting member 132 may be a clamp, a connecting hole or other structures.

The U-shaped member 131 is rotatably connected to the support frame 12, and its rotating shaft X is parallel with the arrangement direction of the two branch arms. The support frame 12 is arranged between the two branch arms of the U-shaped members, the longitudinal motor 11 is fixed on the support frame 12 and is in transmission connection with the U-shaped member 131 to drive the mounting frame 13 to rotate relative to the support frame 12. The use of the two branch arms of the U-shaped member 131 can ensure the stability of the whole mounting frame 13 and fittings during longitudinal movement.

In this embodiment, one branch arm 131a of the U-shaped member 131 is rotatably connected to the support frame 12 while the other branch arm 131b is in transmission connection with the longitudinal motor, thus facilitating the assembling connection of the U-shaped member 131 with the support frame 12 and the longitudinal motor 11. The rotating shaft of the U-shaped member 131 is parallel with the axial direction of the longitudinal motor 11, thereby facilitating the transmission connection between the U-shaped member 131 and the longitudinal motor 11. A longitudinal gearbox for reducing speed is arranged between the longitudinal motor 11 and the U-shaped member 131, and the longitudinal gearbox may be a speed reducer, such as a speed reduction gear bank, so as to ensure the rotation stability of the mounting frame 13. Herein, as another embodiment, it may be that the two branch arms of the U-shaped member 131 are both rotatably connected with the support frame, and the longitudinal motor 11 is in transmission connected with one branch arm of the U-shaped member 131 by means of a transmission shaft and the like.

The support frame 12 is rotatably connected with the housing 9, and its rotating shaft Y is vertical to the rotating shaft of the mounting frame 13; when rotating, the support frame 12 can drive the whole longitudinal vibration damping module 1 to rotate.

The transverse vibration damping module 2 comprises a transverse motor 21 and a reverse mechanism 22 for transmission between two intersecting shafts. The transverse motor 21 is fixed on the housing 9, the axial direction of the transverse motor 21 is vertical to the rotating shaft of the support frame 12, and the transverse motor 21 is in transmission connection with the support frame 12 via the reverse mechanism 22 to drive the support frame 12 to rotate. The transmission between two intersecting shafts can be realized through the reverse mechanism 22, so that the rotating shaft of the output shaft of the transverse motor 21 is mutually vertical to the rotating shaft of the support frame 21, thus helping the transverse motor 21 to drive the support frame 21 to rotate.

The transverse motor 21, the support frame 12, the U-shaped member 131 and the mounting member 132 are arranged in the axial direction of the transverse motor 21 so that the axial direction of the transverse motor is located on the central axis Z of the entire device, and the arrangement of the main components in the direction of the central axis of the device facilitates the structure arrangement of the device on the central axis Z, so that other electronic elements can be arranged within the housing conveniently. The structure layout of the entire device is reasonable, which will help reduce the size of the entire device, facilitates the hand-held use by users and improves use comfort.

Further, the support frame 12 comprises a base 121 and a transmission bar 122. The base 121 is connected with the U-shaped member 131 and the longitudinal motor 11 is fixed on the base 121. The transmission bar 122 is arranged along the axial direction of the transverse motor 21, thus further facilitating the structure layout of the device in the length direction so that other electronic elements can be arranged on one side of the transmission bar 122. A roller mechanism may be arranged between the base 121 and the housing 9, which facilitates the stability of the base 121 during transverse movement.

One end of the transmission bar 122 is fixedly connected with the support frame 12 while the other end is rotatably connected to the housing 9; the whole support frame 12 can rotate relative to the housing 9 through the rotating fit of the transmission bar 122 and the housing 9, and the rotating shaft of the transmission bar 122 is the rotating shaft of the whole support 12. The other end of the transmission bar 122 is in transmission connection with the transverse motor 21 via the reverse mechanism 22.

Specifically, the reverse mechanism 22 comprises a drive bevel gear 221 and a driven bevel gear 222 which are engaged with each other. The drive bevel gear 221 is in transmission connection with the transverse motor 21 and is driven by the transverse motor 21 to rotate.

The driven bevel gear 222 is fixedly connected with the support frame 12. In this embodiment, the driven bevel gear 22 is fixedly connected to the other end of the transmission bar 122 and is rotatably connected to the housing 9 so that the transmission bar 122 is in rotating fit with the housing 9. A fixed post 91 is arranged on the inner wall of the housing 9, and the driven bevel gear 222 is rotatably connected to the fixed post 91, which facilitates the assembling connection between the driven bevel gear 222 and the housing.

A transverse gearbox for reducing speed may be arranged between the reverse mechanism 22 and the transverse motor 21, and the gearbox may be a speed reducer, such as a speed reduction gear bank, so as to ensure the stability of the longitudinal vibration damping module 1 and the fittings during transverse movement. In this embodiment, the transverse gear box may be arranged between the drive bevel gear 221 and the transverse motor 21.

When rotating, the drive bevel gear 221 can drive the driven bevel gear 22 and the support 12 to rotate, which results in simple structure, small space occupation and convenient assembly. Herein, as another embodiment, the reverse mechanism 22 may also be other mechanisms capable of realizing transmission between two intersecting shafts, such as a worm-gear mechanism and a crank-rocker mechanism.

In this embodiment, the arm vibration damping mechanism further comprises a control module (not shown), and the control module comprises a movement sensor and a control chip. The movement sensor is mounted on the housing 9 and used for collecting the vibration data of the housing 9. The vibration of the housing 9 is the vibration of the user's arm because the user holds the housing 9 with a hand when using the device. In order to provide the accuracy of the data, there may be multiple movement sensors. The movement sensor is coupled to the control module to transmit the collected vibration data to the control module. The control module is coupled to the transverse motor 21 and the longitudinal motor 11, and the control module can control the actions of the transverse motor 21 and the longitudinal motor 11 according to the vibration data.

When the arm tremor happens, the device housing 9 has tremor synchronously, at which time the movement sensor collects the following vibration data (including but not limited to): translational acceleration in three directions x/y/z, the rotation speed in three directions x/y/z and location information and other data; after the collected vibration data are analyzed and processed by the control chip, the tremor speed, tremor frequency, tremor amplitude and other data are calculated, and algorithm analysis is carried out based on these data to obtain the size of strength to be compensated; and then the control chip gives a corresponding voltage instruction to the transverse motor 21 and the longitudinal motor 11 to regulate and control the rotation speeds of the transverse motor 21 and the longitudinal motor 11, thus driving the mounting frame 13 to move laterally and longitudinally to counteract the tremor from the opposite direction so as to reduce the influence caused by arm tremor.

Further, the arm vibration damping device further comprises a battery powering module, a wireless charging module and a wireless charger. The battery powering module and the wireless charging module are both arranged in the housing, and the battery powering module is electrically connected to the control module to provide power for the entire device. The battery charging module is connected with the wireless charging module, the wireless charging device is arranged outside the housing, and the wireless charging module is connected with the wireless charger through a coil coupling sensing technology, wherein the wireless charger enables the coil of the wireless charging module to generate an induced current through electro-magnetic induction to charge the battery powering module.

In order to facilitate the data analysis, the arm vibration damping device further comprises a wireless communication module (which may be based on 2G, 3G, 4G, Bluetooth, etc.), can communicate with an APP through a wireless network to carry out the wireless upgrade of software version, and can upload arm tremor data through a wireless network to carry out effect analysis.

The above description refers to preferred embodiments of the present invention, and it should be noted that it will be apparent to those skilled in the art that a number of improvements and modifications may be made without departing from the principles of the present invention, and these improvements and modifications also should be considered as falling within the protection scope of the present invention.

1. An arm vibration damping device, comprising a housing, a longitudinal vibration damping module and a transverse vibration damping module, wherein the longitudinal vibration damping module and the transverse vibration damping module are both arranged in the housing, the longitudinal vibration damping module is used for driving fittings to carry out longitudinal vibration damping, and the transverse vibration damping module is used for driving the longitudinal vibration damping module and fittings to carry out longitudinal vibration damping;
the longitudinal vibration damping module comprises a longitudinal motor, a support frame and a mounting frame; the longitudinal motor is mounted on the support frame; the mounting frame comprises a U-shaped member and a mounting member used for mounting fittings; the joint of the two branch arms of the U-shaped member is fixedly connected with the mounting member; the U-shaped member is rotatably connected to the support frame and a rotating shaft of the U-shaped member is parallel with the arrangement direction of the two branch arms; the support frame is located between the two branch arms of the U-shaped member; the longitudinal motor is in transmission connection with the U-shaped member to drive the mounting frame to rotate relative to the support frame; the support frame is rotatably connected to the housing and a rotating shaft of the support frame is vertical to a rotating shaft of the mounting frame;
the transverse vibration damping module comprises a transverse motor and a reverse mechanism used for transmission between two intersecting shafts; the transverse motor is fixed on the housing; the axial direction of the transverse motor is vertical to the rotating shaft of the support frame; the transverse motor is in transmission connection with the support frame via the reverse mechanism to drive the support frame to rotate; the transverse motor, the support frame, the U-shaped member and the mounting member are arranged along the axial direction of the transverse motor.

2. The arm vibration damping device according to claim 1, wherein the mounting member is of a bar shape, arranged along the axial direction of the transverse motor, one end of the mounting member is fixedly connected with the U-shaped member and the other end extends out of the housing to connect with fittings.

3. The arm vibration damping device according to claim 1, wherein one branch arm of the U-shaped member is rotatably connected to the support frame while the other branch arm is in transmission connection with the longitudinal motor.

4. The arm vibration damping device according to claim 3, wherein the rotating shaft of the U-shaped member is parallel with the axial direction of the longitudinal motor.

5. The arm vibration damping device according to claim 1, wherein the support frame comprises a base and a transmission bar; the base is connected with the U-shaped member and the longitudinal motor is fixed on the base; the transmission bar is arranged along the axial direction of the transverse motor, one end of the transmission bar is fixedly connected with the support frame and the other end is rotatably connected to the housing.

6. The arm vibration damping device according to claim 5, wherein a roller mechanism is arranged between the base and the inner wall of the housing.

7. The arm vibration damping device according to claim 1, wherein the reverse mechanism comprises a drive bevel gear and a driven bevel gear which are engaged with each other; the drive bevel gear is in transmission connection with the transverse motor and is driven by the transverse motor to rotate; the driven bevel gear is fixedly connected with the support frame and is rotatably connected with the housing.

8. The arm vibration damping device according to claim 7, wherein a fixed post is arranged on the inner wall of the housing, and the driven bevel gear is rotatably connected to the fixed post.

9. The arm vibration damping device according to claim 1, wherein a longitudinal gearbox for reducing speed is arranged between the longitudinal motor and the U-shaped member;
a transverse gearbox for reducing speed is arranged between the reverse mechanism and the transverse motor.

10. The arm vibration damping device according to claim 1, further comprising a control module, wherein the control module comprises a movement sensor and a control chip; the movement sensor is mounted on the housing and used for collecting the vibration data of the housing; the movement sensor is coupled to the control module to transmit the collected vibration data to the control module; the control module is coupled to the transverse motor and the longitudinal motor, and the control module can control the actions of operation of the transverse motor and the longitudinal motor.
